(19) United States
(12) Patent Application Publication
(10) Pub. No.: US 2008/0029608 A1
(43) Pub. Date: Feb. 7, 2008

(54) Biometric session activation and control for a transaction card

(75) Inventors: John M. Kellum, Woodinville, WA (US); Kristopher C. Billmaier, Kirkland, WA (US); David P. Billmaier, Woodinville, WA (US); James A. Billmaier, Woodinville, WA (US)

Correspondence Address: FSP LLC, P.O. BOX 890, VANCOUVER, WA, 98666, US

(73) Assignee: Patent Navigation Inc., Woodinville, WA (US)

(21) Appl. No.: 11/724,028

(22) Filed: Mar. 13, 2007

Related U.S. Application Data
(60) Provisional application No. 60/782,318, filed on Mar. 13, 2006.

(51) Int. Cl. G06K 19/06

(52) U.S. Cl. 235/492

(57) ABSTRACT

A transaction card may include a first biometric sensor and logic to activate a transaction session for the card upon authenticating a biometric input. The card may further include logic to deactivate the transaction card upon expiration of the transaction session.

### CROSS REFERENCE TO RELATED APPLICATIONS

This application claims priority to U.S. Provisional Patent Application Ser. No. 60/782,318, having the title BIOMETRIC SESSION ACTIVATION AND CONTROL FOR A TRANSACTION CARD, filed on Mar. 13, 2006. The entire specification of which is hereby incorporated by reference for all purposes.

### TECHNICAL FIELD

The present disclosure relates to biometric identification for transaction cards.

### BACKGROUND

Biometric authentication and authorization provide for greater security for transaction cards, such as credit or debit cards. Examples of biometrics are fingerprint analysis and voice recognition.

One problem with biometrics is that they may require continuous application of the biometric input in order to maintain activation of the transaction card, which may be inconvenient. Another problem is that the user or other parties may not have a good indication that the card's provider has been authenticated and/or authorized.

Limitations such as these may result in slower and less widespread adoption of biometrically-enabled transaction cards.

### SUMMARY

The following summary is intended to highlight and introduce some aspects of the disclosed embodiments, but not to limit the scope of the claims. Thereafter, a detailed description of illustrated embodiments is presented, which will permit one skilled in the relevant art to make and use various embodiments.

A transaction card may include and/or involve a first biometric sensor, logic to activate a transaction session for the card upon authenticating a biometric input, and logic to deactivate the transaction card upon expiration of the transaction session.

The transaction card may include and/or involve logic to provide at least one of audio, visual, or tactile feedback indicating that the session is in progress.

The transaction card may include and/or involve logic to provide at least one of audio, visual, or tactile feedback indicating that the session will imminently expire.

The transaction card may include and/or involve logic to provide at least one of audio, visual, or tactile feedback indicating that the session has expired.

The transaction card may include and/or involve logic to deactivate the transaction card upon detecting a second biometric input from the first biometric sensor or a biometric input from a second biometric sensor different than the first. The logic to deactivate the transaction card upon detecting a second biometric input from the first biometric sensor or a biometric input from a second biometric sensor different than the first may include and/or involve logic to deactivate the transaction card upon receiving a second fingerprint different than a first fingerprint used to activate the session, and/or logic to deactivate the transaction card upon detecting a voice command different than a voice command that activated the session.

Other system/method/apparatus aspects are described in the text (e.g., detailed description and claims) and drawings forming the present application.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is an illustration of an embodiment of a transaction card with biometric session tracking.

FIG. 2 is a flow chart of an embodiment of a biometrically enabling session for a transaction card.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

Transaction Card with Biometric Session Tracking

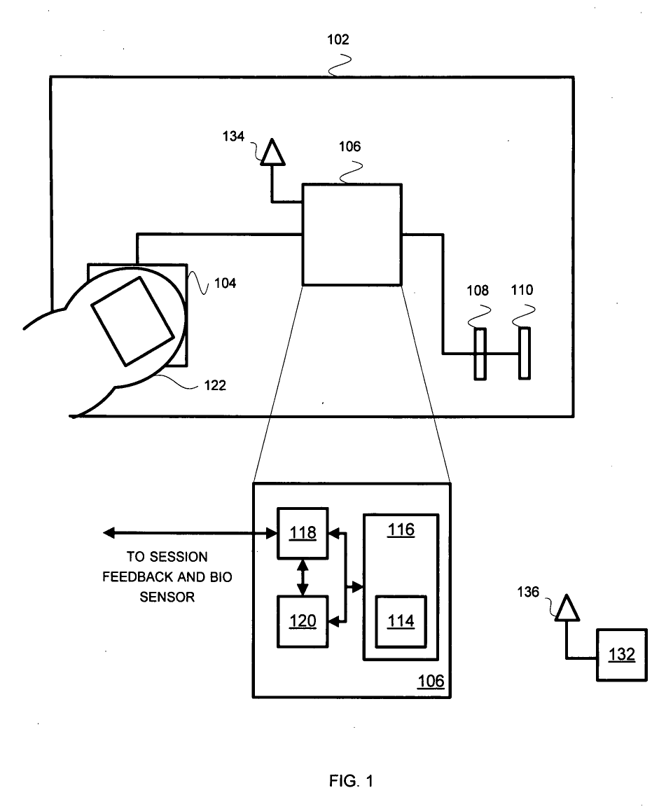

FIG. 1 is an illustration of an embodiment of a transaction card with biometric session tracking.

A transaction card 102 comprises a first biometric sensor 104, elements to accomplish processing 106, and human feedback elements, in this case, a sound generator 108 and light generator 110 such as an LED.

The processing elements 106 may comprise a microprocessor 120, memory 116, Input/Output (I/O) interface logic 118, and logic 114 to activate a transaction session for the card upon authenticating a biometric input and to deactivate the transaction card upon expiration of the transaction session.

The transaction card 102 has been illustrated at a point in time when a user's finger 122 is close to or touching the biometric sensor 104. Moving a finger 122 close to or touching the sensor 104 may act to initiate the logic 114 such that authentication may occur and a transaction session may begin. The transaction session may be timed such that use of the card is terminated even if the transaction is not completed after a period of time.

The transaction card 102 may comprise different or other elements than those illustrated. Other types of feedback may be present additionally or partially or totally in place of the feedback sensors 108 and 110 shown. For example, a one line display may provide visual feedback of card status, or the card may employ a vibration transducer.

The processing capability 106 of the transaction card 102 may include logic 114 and/or other elements, for example, a timer, to facilitate session timing.

Also, the card 102 may have multiple biometric sensors and/or additional mechanisms for obtaining human and/or data input in addition to the biometric sensor 122 shown. For example, the card may, in some embodiments, communicate wirelessly or via an electrical interface with another electronic device when it is near it or inserted into it. A person may interact with the logic 114 within the card by providing inputs and responses on the other electronic device. In other words, one or more other devices may provide input/output capabilities to the card 102.

In one embodiment having multiple biometric sensors, one sensor 104 may be used to start the session and another sensor (not illustrated) may be used to disable the card after, or even before, the session expires.

In some embodiments, the biometric sensor 104 may be used in conjunction with the processing 106 capability to enable additional inputs for purposes beyond authentication/authorization and session initiation. For example, the transaction card 102 may comprise a biometric input 104 with voice capture capability for the purposes of responding to queries associated with the transaction.

The transaction card may include logic 114 to provide at least one of audio, visual, or tactile feedback indicating the state of the transaction card. The audio, visual, or tactile feedback may indicate that a session is in progress, imminently to expire, and/or expired. An example of visual feedback is an LED or one line display possibly provided by a grouping of LEDs. To indicate differing states, the LED might be flashed in different patterns, or may comprise different colors.

One example of audio feedback is tones. Several distinct tones may be used to indicate different states, one for authentication failed, one for session in progress, one for session terminated, and so on. In some cases, a single tone may be used for feedback, but provided in differing patterns depending on the desired communication. A vibration effect or effects may be used similarly.

The transaction card 102 may include logic 114 to provide at least one of audio, visual, or tactile feedback indicating that the session will imminently expire.

The transaction card 102 may include logic 114 to provide at least one of audio, visual, or tactile feedback indicating that the session has expired.

The transaction card 102 may include logic 114 to provide at least one of audio, visual, or tactile feedback indicating that a transaction session encountered a problem and did not complete successfully.

The transaction card 102 may include logic 114 to provide at least one of audio, visual, or tactile feedback indicating that a transaction session completed successfully.

The transaction card 102 may include logic 114 to deactivate the transaction card 102 (deactivation logic) upon detecting a second biometric input from the first biometric sensor 104 or a biometric input from a second biometric sensor different than the first. For example, when the biometric sensor 104 has fingerprint recognition capability of some manner, a person may start a session by placing a finger 122 on or close to a first area of the card 102, and end the session by placing a finger 122 (not necessarily the same finger) on or close to a different area of the card. As another example, when the card 102 is not in session, a first finger touch or close may initiate the session. If a session is in progress, a finger touch or close may end the session.

The deactivation logic 114 may deactivate the transaction card 102 upon receiving a second fingerprint different than a first fingerprint used to activate the session. For example, one biometric sensor 104 may be used but different fingers such as a thumb 122 or index finger may be used to start and stop the session.

When the transaction card 102 has voice capture and processing capability, the deactivation logic 114 may deactivate the transaction card 102 upon detecting a voice command different than a voice command that activated the session. Thus, voice recognition (identifying a particular combination of sounds for successful authentication and session initiation, i.e., card activation) may be used to begin a session. A different voice command may then terminate the session, i.e., deactivate the card 102.

In some embodiments, the deactivation logic 114 may deactivate the card 102 when another device 132, associated with a holder of the card 102, is not proximate. The card 122 and the device may communicate wirelessly via antennae 134, 136. The person holding the card 122 may have an identifier 132 on his person. The device 132 may be a separate device/tag (e.g. RFID), or included in another device like automobile FOB, cell phone, a personal digital assistant, etc.). An ID of the device 132 may be matched to an ID of the card 122. If the card 122 is out of wireless communication range from the other device 132, it may be disabled by the deactivation logic 114.

In some embodiments, the card 122 and the device 132 have a series of matching identifiers. Each time the card 122 is used, both the card 122 and the device 132 advance to the next identifier which must match to use the card 122 the next time.

In some embodiments, the device 132 may be used to verify secure transactions online. A sales device accepting the card 122 or a number of the card 122 may verify the ID of the device 132 carried by the person holding the card 122, before accepting the card 122 or card number for a transaction.

Biometrically Enabling a Session for a Transaction Card

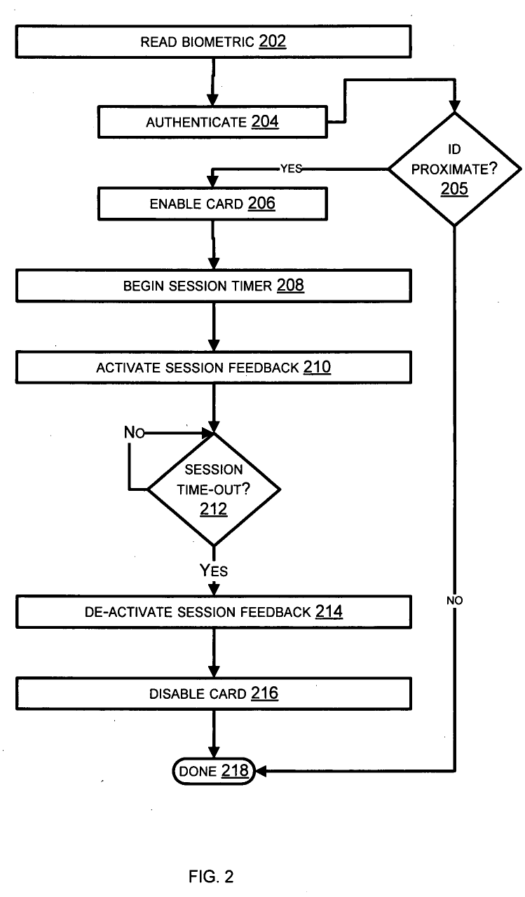

FIG. 2 is a flow chart of an embodiment of biometrically enabling a session for a transaction card.

At 202, the card reads a biometric input. Among other possibilities, the biometric input could be a fingerprint or a voice input. If the latter, the biometric input may specifically be a command such as “session start” voiced by a person authorized to initiate card processing.

At 204, the card authenticates the input. Authentication, if the biometric input was a fingerprint, may include recognizing a particular fingerprint pattern. If the biometric input involved voice data, authentication may include recognizing both a sound pattern unique to a particular word or words and sound features characteristic to a particular person or persons.

For some embodiments, act 205 may occur, in which proximity is determined with an associated wireless device. For example, if an associated wireless device (e.g. device 132) is not identified as proximate, the card is not enabled for transactions. If proximity is determined with an associated device, processing may proceed to enable a transaction session at 206.

At 206, authentication is successful and the card enables a transaction session. If, at this point, authentication was not successful, the card may instead terminate its processing of the session. In some embodiments, the card may communicate that authentication was unsuccessful using some feedback mechanism such as a visual, sound, or vibration mechanism. These might be expressed for some period of time, after which the card would be in a state waiting for a biometric input as per 202.

At 208, the card begins a timer for the session. At 210, the card activates session feedback. The nature of the session feedback may depend on the feedback mechanisms provided by the particular embodiment. For example, the card may turn on an LED of a particular color (say green). Or, the card may activate a vibration generator. Or the card may initiate a small chirping tone. If the card includes a one line display, it might be sent a short message such as “session in progress”.

In some embodiments, for example when the card provides session-in-progress feedback using a vibration generator or a tone, it may terminate the session-in-progress feedback after some interval of time even though the session continues to be in progress. In other embodiments, such as is shown in this processing flow, the session in progress feedback will be “turned on” and will remain active for the duration of the session.

At 212, the card determines if the session timer has expired, i.e., if the session has timed out. If the session has not timed out, this action will continue until it does, or until some other session-ending action occurs. During this period of waiting for timeout or session completion, the feedback mechanism may continue to be expressed. For example, the LED may continue to express a green light. As a second example, the card may continue to express the chirping tone.

At 214, the card, having recognized that the session has timed out, deactivates the session feedback mechanism which, when active, is used to indicate the session is active. For example, if a green LED was on during the active session time, it may now be turned off. In some embodiments, the card may alternatively recognize that the transaction session is now over for some other reason. For example, the card may recognize that the transaction being performed during the transaction session has been successfully completed or has unsuccessfully ended. Still another reason for recognizing that the session would be over would be that an active action has occurred to terminate it. For example, a person may have used a biometric sensor to provide a fingerprint or voice input indicating that the session should be terminated.

In some embodiments, feedback may be generated both by turning off the “session active” feedback mechanism and by providing feedback as to how the session ended. For example, if a green LED is on during the active session time, the LED may be set from green on to a blinking green state for some period of time to indicate successful completion. After that, it may be turned off.

In some embodiments, different feedback may be provided if the session failed either by timing out while not accomplishing anything or by otherwise ending unsuccessfully. This may occur, for example, because an authorized person issued a voice command to “end session”. Rather than going to a blinking green LED as per the successful completion example, the green LED may be turned off completely (no blinking) and a red LED may be activated for a period of time. Depending on the feedback mechanism(s) used and the amount of information to be conveyed, many embodiments are possible. In some, session feedback indicating an “in progress” state will have been provided, and this feedback will be turned off when the session state is no longer in progress. Additional amounts of feedback depend on the control and feedback mechanism(s) provided by the card and the feedback needs of a particular application.

At 216, the card places itself in an inactive state. At 218, processing is complete.

Not shown in this processing flow, but as another example of the types of additional feedback provided in some embodiments, is session-about-to-expire feedback. When the transaction card supports a session-about-to-expire warning capability, the timer may first be set to expire not for session expiration but for some shorter time period. Thus when the timer expires, the card may change the session-in-progress feedback it has active to a session-about-to-expire feedback state. For example, if audible session in progress feedback was initially provided (say by a chirping sound provided at some slow frequency for a time period i.e.—chirp—wait a second—chirp), the audible feedback may now be provided but at a fast chirping state i.e.—chirp—chirp—chirp—indicating that the transaction should be completed quickly because this session is about to expire. The card may then reinitiate the timer in order to recognize the actual moment of session timeout, with processing flow as before to detect the session timeout.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A transaction card comprising:
a first biometric sensor;
logic to activate a transaction session for the card upon authenticating a biometric input; and
logic to deactivate the transaction card upon expiration of the transaction session.

2. The transaction card of claim 1, further comprising:
logic to provide at least one of audio, visual, or tactile feedback indicating that the session is in progress.

3. The transaction card of claim 1, further comprising:
logic to provide at least one of audio, visual, or tactile feedback indicating that the session will imminently expire.

4. The transaction card of claim 1, further comprising:
logic to provide at least one of audio, visual, or tactile feedback indicating that the session has expired.

5. The transaction card of claim 1, further comprising:
logic to deactivate the transaction card upon detecting a second biometric input from the first biometric sensor or a biometric input from a second biometric sensor different than the first.

6. The transaction card of claim 5, wherein the logic to deactivate the transaction card upon detecting a second biometric input from the first biometric sensor or a biometric input from a second biometric sensor different than the first further comprises:
logic to deactivate the transaction card upon receiving a second fingerprint different than a first fingerprint used to activate the session.

7. The transaction card of claim 5, wherein the logic to deactivate the transaction card upon detecting a second biometric input from the first biometric sensor or a biometric input from a second biometric sensor different than the first further comprises:
logic to deactivate the transaction card upon detecting a voice command different than a voice command that activated the session.

8. A transaction card comprising:
logic to activate a transaction session for the card upon detection of a proximate wireless device, and to fail activation if the proximate wireless device is not detected.
